(19) United States
(12) Patent Application Publication
(10) Pub. No.: US 2026/0162055 A1
(43) Pub. Date: Jun. 11, 2026

(54) INFORMATION PROCESSING APPARATUS AND CONTAINER ARRANGEMENT METHOD

(71) Applicant: Fujitsu Limited, Kawasaki-shi (JP)

(72) Inventors: Tatsuya TAKANAGA, Kawasaki (JP); Ayano HASOME, Kawagoe (JP); Masataka KAIHARA, Taito (JP)

(73) Assignee: Fujitsu Limited, Kawasaki-shi (JP)

(21) Appl. No.: 19/404,545

(22) Filed: Dec. 1, 2025

(30) Foreign Application Priority Data
Dec. 5, 2024 (JP) 2024-212499

(51) Int. Cl. G06Q 10/083; G06Q 10/04

(52) U.S. Cl. CPC G06Q 10/0843; G06Q 10/04

(57) ABSTRACT

A processing unit acquires a predicted retrieval time for each container to be arranged in a storage location (predetermined area), and an estimated value of the standard deviation of the error between the predicted retrieval time and an actual retrieval time. The processing unit determines, for each container pair, a weight coefficient representing a swapping probability of a retrieval order, using the predicted retrieval time and the estimated value. The processing unit formulates a linear programming problem relating to the container arrangement, using an objective function in which decision variables are weighted by the weight coefficients. Each decision variable indicates, for a container pair, whether a first container is stacked on a second container having a later retrieval time. The processing unit performs a solving process of the linear programming problem according to the objective function, and outputs arrangement information on the containers as a solving result.

### CROSS-REFERENCE TO RELATED APPLICATION

This application is based upon and claims the benefit of priority of the prior Japanese Patent Application No. 2024-212499, filed on Dec. 5, 2024, the entire contents of which are incorporated herein by reference.

### FIELD

The embodiments discussed herein relate to an information processing apparatus and a container arrangement method.

### BACKGROUND

In port operations, containers are unloaded from ships, are temporarily stored in storage locations, and are subsequently retrieved using vehicles such as trucks. Such operations are sometimes referred to as container handling.

In the limited space of storage locations, containers may be stacked in a vertical direction (height direction). If, during the retrieval of containers from a storage location in a predetermined order, a desired container to be retrieved earlier is located under another container to be retrieved later, a re-handling operation needs to be performed, in which the other container is moved in order to retrieve the desired container.

In related art, methods for improving the efficiency of container retrieval have been proposed (for example, see Japanese National Publication of International Patent Application No. 2017-521333 and Japanese Laid-open Patent Publication No. 2002-302261). In addition, a method has been proposed in which the arrangement of containers is formulated as an integer programming problem so as to minimize the number of re-handling operations (for example, see S. Boge and S. Knust, “The parallel stack loading problem minimizing the number of reshuffles in the retrieval stage”, European Journal of Operational Research, Vol. 280, Issue 3, 1 Feb. 2020, pp. 940-952).

### SUMMARY

In one aspect, there is provided a non-transitory computer-readable storage medium that stores a computer program that causes a computer to perform a process including: acquiring a predicted retrieval time for each of a plurality of containers to be arranged in a predetermined area, and an estimated value of a standard deviation of an error between the predicted retrieval time and an actual retrieval time; determining, for each container pair among the plurality of containers, a weight coefficient representing a swapping probability that a retrieval order is swapped relative to a predicted retrieval order represented by the predicted retrieval time, using the predicted retrieval time and the estimated value; formulating a linear programming problem relating to an arrangement of the plurality of containers in the predetermined area, using an objective function in which decision variables are weighted by weight coefficients, the variables each indicating, with respect to a decision container pair of a first container and a second container having a later predicted retrieval time than the first container, whether the first container is stacked on the second container; performing a solving process of the linear programming problem according to the objective function; and outputting arrangement information on the plurality of containers for the predetermined area, as a result of the solving process.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a container arrangement method according to a first embodiment;

FIG. 2 is a diagram for describing an example of container handling;

FIG. 3 is a diagram for describing an example of re-handling;

FIG. 4 illustrates an example of a retrieval order and a set A^{U} in the case where the number of containers is n=5;

FIG. 5 illustrates an example of a result of investigating a history of actual retrieval times;

FIG. 6 is a diagram for describing an example in which the retrieval order of containers is swapped;

FIG. 7 illustrates an example of hardware of an information processing apparatus according to a second embodiment;

FIG. 8 is a block diagram illustrating an example of functions of the information processing apparatus;

FIG. 9 is a flowchart illustrating an example of a processing procedure of the information processing apparatus according to the second embodiment;

FIG. 10 illustrates the results of Experimental Example 1;

FIG. 11 illustrates the results of Experimental Example 2; and

FIG. 12 illustrates an application example of a container arrangement method according to the second embodiment.

### DESCRIPTION OF EMBODIMENTS

In the case where a plurality of containers are arranged in a predetermined area using a conventional formulation method, delays in the arrival times of vehicles that will retrieve the containers or other factors may cause changes in the retrieval order of the containers, which may result in an increased number of re-handling operations. Hereinafter, embodiments will be described with [0022] reference to the drawings. A plurality of embodiments may be combined unless they exclude each other.

### First Embodiment

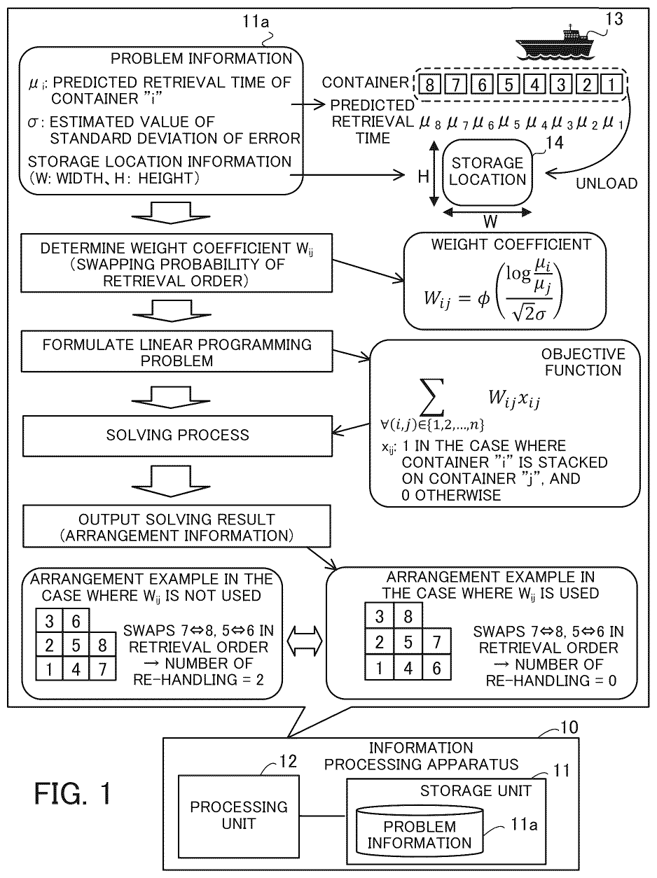

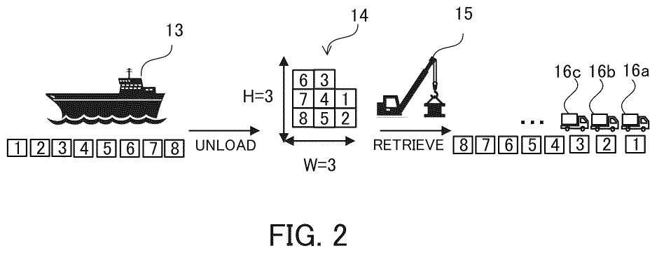

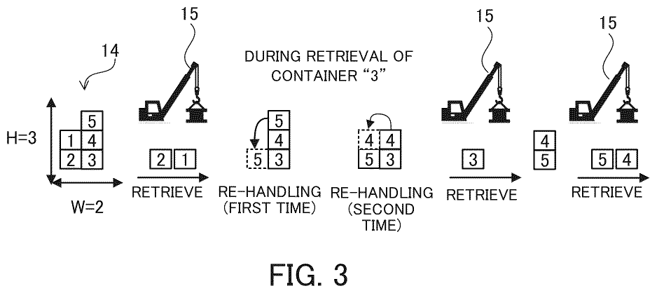

FIG. 1 illustrates an example of a container arrangement method according to a first embodiment. FIG. 2 is a diagram for describing an example of container handling. FIG. 3 is a diagram for describing an example of re-handling.

First, an example of container handling will be described with reference to FIG. 2. In FIG. 2, blocks “1” to “8” represent eight containers.

FIG. 2 illustrates an example in which the containers “8” to “1” are sequentially unloaded from a ship 13 and carried into a predetermined area having a width W and a height H (hereinafter, referred to as a storage location 14) in that order. The width W is defined as the number of containers that are able to be arranged in the horizontal direction. The height H is defined as the number of containers that are able to be arranged in the height direction. In the example of FIG. 2, W=3 and H=3. It is assumed that the number of containers that are able to be arranged in the depth direction in FIG. 2 is one (the same applies hereinafter).

In the arrangement example of FIG. 2, the containers “8”, “5”, and “2” are placed at the bottom of the storage location 14. The containers “7” and “6” are stacked in this order on the container “8”, the containers “4” and “3” are stacked in this order on the container “5”, and the container “1” is stacked on the container “2”.

The containers temporarily stored in the storage location 14 are retrieved by vehicles 16a, 16b, 16c, and others using a crane 15, for example. In the container arrangement illustrated in FIG. 2, in the case where the containers are retrieved in the order of the containers “1” to “8”, re-handling does not occur.

FIG. 3 illustrates an example of an arrangement of the containers “1” to “5” in the storage location 14 with W=2 and H=3. In the arrangement example of FIG. 3, the containers “2” and “3” are placed at the bottom of the storage location 14. The container “1” is stacked on the container “2”, and the containers “4” and “5” are stacked in this order on the container “3”.

In this container arrangement, in the case where the containers are retrieved in the order of the containers “1”, “2”, “3”, “4”, and “5”, re-handling occurs as illustrated in FIG. 3. Specifically, no re-handling occurs during the retrieval of the containers “1” and “2”. However, in order to retrieve the container “3”, a re-handling operation is needed twice, in which the containers “4” and “5” stacked on the container “3” are moved. No re-handling occurs during the subsequent retrieval of the containers “4” and “5”.

Such re-handling may account for approximately 20% of the entire container handling operation, and it is therefore desirable to reduce the number of re-handling operations.

The first embodiment described below relates to a container arrangement method capable of presenting a container arrangement so as to reduce the number of re-handling operations during retrieval when containers unloaded from a ship are temporarily arranged in a storage location at a port facility.

FIG. 1 illustrates an information processing apparatus 10 for implementing the container arrangement method. The information processing apparatus 10 is able to implement the container arrangement method by executing a container arrangement program, for example.

The information processing apparatus 10 includes a storage unit 11 and a processing unit 12. The storage unit 11 is, for example, a memory or a storage device included in the information processing apparatus 10. The processing unit 12 is, for example, a processor or an arithmetic circuit included in the information processing apparatus 10.

The storage unit 11 stores problem information 11a, which includes a predicted retrieval time μᵢ for each of a plurality of containers to be arranged in a storage location, and an estimated value σ of the standard deviation of the error between the predicted retrieval time μᵢ and an actual retrieval time.

For example, as illustrated in FIG. 1, in the case of a problem of determining a container arrangement when the eight containers “1” to “8” are unloaded from the ship 13 and arranged in the storage location 14, the predicted retrieval times μ₁ to μ₈ of the containers “1” to “8” are included in the problem information 11a. The predicted retrieval times μ₁ to μ₈ are set based on, for example, the predetermined scheduled arrival times of the vehicles that will retrieve the containers “1” to “8”.

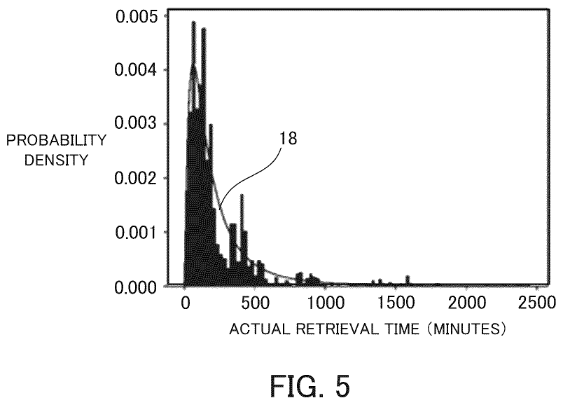

The estimated value σ of the standard deviation of the error is calculated based on, for example, a history of actual retrieval times (see FIG. 5 described later). Alternatively, the estimated value σ may be an empirically assumed value.

The problem information n 11a further includes storage location information, which is used for determining constraints for arranging the plurality of containers in the storage location 14. The storage location information is information on a space in which containers are to be arranged, and includes the width W and the height H of the storage location 14. The width W is defined as the number of containers that are able to be arranged in the horizontal direction. The height H is defined as the number of containers that are able to arranged in the height direction. Note that in order to simplify the problem, it is assumed that the containers have the same size (length, width, and height).

The processing unit 12 performs the following container arrangement process. The processing unit 12 acquires the problem information 11a. The processing unit 12 stores the acquired problem information 11a in the storage unit 11. The problem information 11a may be input by a user of the information processing apparatus 10 via an input device and stored in the storage unit 11, or may be input via a network and stored in the storage unit 11.

The processing unit 12 determines a weight coefficient Wᵢⱼ for each container pair among the plurality of containers, using the predicted retrieval time μᵢ and the estimated value σ. The weight coefficient Wᵢⱼ indicates a swapping probability that the retrieval order will be swapped relative to the predicted retrieval order represented by the predicted retrieval time μᵢ. Such a weight coefficient Wᵢⱼ is used for formulating a problem taking into account the possibility that t the retrieval order of containers is swapped due to a delay in the arrival time of any of a plurality of vehicles (trucks or the like) that will retrieve the plurality of containers at the storage location 14.

The swapping probability P(Y₁>Y₂) that the retrieval order of the container “1” with the predicted retrieval time μᵢ and the container “2” with the predicted retrieval time μ₂ later than the predicted retrieval time μ₁ is swapped may be expressed by the following Formula (1).

$$\begin{matrix}P ( {Y}_{1} > {Y}_{2} ) = P ( exp ( log ( {μ}_{1} ) + {ε}_{1} ) > exp ( log ( {μ}_{2} ) + {ε}_{2} ) ) \\ = P ( {μ}_{1} exp ( {ε}_{1} ) > {μ}_{2} exp ( {ε}_{2} ) ) \\ = P ( \frac{{μ}_{1}}{{μ}_{2}} exp ( {ε}_{1} - {ε}_{2} ) < 1 ) \\ = P ( log \frac{{μ}_{2}}{{μ}_{1}} < {ε}_{1} - {ε}_{2} ) \\ = P ( log \frac{{μ}_{2}}{{μ}_{1}} < N ( 0 , \sqrt{{σ}^{2} + {σ}^{2}} ) ) \\ = P ( \frac{log \frac{{μ}_{2}}{{μ}_{1}}}{\sqrt{2} σ} < \frac{N ( 0 , \sqrt{2} σ )}{\sqrt{2} σ} ) \\ = P ( \frac{log \frac{{μ}_{2}}{{μ}_{1}}}{\sqrt{2} σ} < Z ) \\ = 1 - P ( Z \leq \frac{log \frac{{μ}_{2}}{{μ}_{1}}}{\sqrt{2} σ} ) \\ = 1 - ϕ ( \frac{log \frac{{μ}_{2}}{{μ}_{1}}}{\sqrt{2} σ} ) \\ = ϕ ( \frac{log \frac{{μ}_{1}}{{μ}_{2}}}{\sqrt{2} σ} )\end{matrix} \qquad ( 1 )$$

Y₁ represents an actual retrieval time of the container “1” with the predicted retrieval time μᵢ, and Y₂ represents an actual retrieval time of the container “2” with the predicted retrieval time μ₂. Further, ε₁ and ε₂ both follow a normal distribution with a mean of 0 and σ, which is represented as N(0, σ). The reason why the actual retrieval times Y₁ and Y₂ are expressed as exp(log(μ₁)+(ε₁) and exp(log(μ₂)+(ε₂), as in Formula (1), will be described later (see FIG. 5).

In Formula (1), ε₁-ε₂ is synthesized due to the reproducibility of the normal distribution in the fifth line. In the sixth line, normalization is performed so as to follow the standard normal distribution Z=N(0, 1). Then, as seen in the ninth and tenth lines, the swapping probability P(Y₁>Y₂) is expressed by a cumulative distribution function φ(x) of the standard normal distribution using the predicted retrieval times μ₁ and μ₂ and the estimated value σ of the standard deviation. The cumulative distribution function φ(x) is defined by the following Formula (2).

$$ϕ ( x ) = \frac{1}{\sqrt{2 π}} {\int }_{- ∞}^{x} {e}^{{t}^{2}} dt \qquad ( 2 )$$

The swapping probability P(Y₁>Y₂) as described above is usable as the weight coefficient W₁₂. Similarly, the swapping probability P(Y₁>Y₂) is usable as the weight coefficient Wᵢⱼ for other container pairs. That is, the weight coefficient Wᵢⱼ is expressed by the following Formula (3).

$${W}_{ij} = ϕ ( \frac{log \frac{{μ}_{i}}{{μ}_{j}}}{\sqrt{2} σ} ) \qquad ( 3 )$$

The larger the weight coefficient Wᵢⱼ is, the higher the probability of Yᵢ>Yⱼ will be, and the higher the likelihood that re-handling will occur. Therefore, the weight coefficient Wᵢⱼ is also regarded as representing the probability of re-handling.

The processing unit 12 formulates a linear programming problem relating to the arrangement of a plurality of containers in the storage location 14, using an objective function in which a decision variable xᵢⱼ is weighted by the weight coefficient Wᵢⱼ. The decision variable xᵢⱼ indicates, for a container pair of a first container (hereinafter, referred to as container “i”) and a second container (hereinafter, referred to as container “j”) whose predicted retrieval time is later than that of the container “i”, whether the container “i” is stacked on the container “j”.

In the following description, it is assumed that xᵢⱼ=1 in the case where the container “i” is stacked on the container “j”, and xᵢⱼ=0 otherwise.

The objective function represents the number of re-handling operations during retrieval, and is expressed by the following Formula (4).

$${\sum }_{∀ ( i , j ) ∈ \{ 1 , 2 , ... , n \}} {W}_{ij} {x}_{ij} \qquad ( 4 )$$

In Formula (4), n denotes the total number of containers. A larger value of the objective function indicates a greater number of re-handling operations. Therefore, a solution (optimal solution) to the linear programming problem is represented by a combination of values of the decision variables xᵢⱼ that minimizes the value of the objective function while satisfying various constraints described below.

In the linear programming problem relating to the arrangement of containers in the storage location 14, the constraints are formulated by the following Formulae (5) to (8).

$${\sum }_{j = 0}^{i - 1} {x}_{ij} = 1 , ∀ i ∈ \{ 1 , 2 , ... , n \} \qquad ( 5 )$$

Formula (5) represents a constraint that another container “j” is placed under a container “i” (i.e., the container “i” is stacked on another container “j”). This constraint is used to avoid a solution in which no container is located under the container “i”. The constraint is formulated such that, in the case where the container “i” is placed at the bottom, the container “i” is regarded as being stacked on a dummy container (j=0).

$${\sum }_{i = j + 1}^{n + 1} {x}_{ij} = 1 , ∀ j ∈ \{ 1 , 2 , ... , n \} \qquad ( 6 )$$

Formula (6) represents a constraint that another container “i” is stacked on a container “j”. This constraint is used to avoid a solution in which no container is located on the container “j”. The constraint is formulated such that, in the case where the container “j” is located at the top, a dummy container (j=n+1) is regarded as being stacked on the container “j”.

$${\sum }_{i = 1}^{n} {x}_{i 0} \leq W \qquad ( 7 )$$

Formula (7) represents a constraint that the number of containers arranged in the horizontal direction is equal to or less than the width W of the storage location 14.

$${l}_{j} + 1 - H ( 1 - {x}_{ij} ) \leq {l}_{i} , ∀ i ∈ \{ 1 , 2 , ... , n \} , ∀ j ∈ \{ 0 , 1 , ... , i - 1 \} \qquad ( 8 )$$

$$1 \leq {l}_{i} \leq H , ∀ i ∈ \{ 1 , 2 , ... , n \}$$

$${l}_{0} = 0$$

$${x}_{ij} ∈ \{ 0 , 1 \} , ∀ i ∈ \{ 1 , 2 , ... , n \} , ∀ j ∈ \{ 0 , 1 , ... , i - 1 \}$$

Formula (8) represents a constraint concerning the height at which each container is located. In Formula (8), lᵢ and lⱼ are decision variables indicating the vertical position of the containers “i” and “j”, respectively, counted from the bottom. In other words, lᵢ and lⱼ represent the heights (or the positions in the height direction) of the containers “i” and “j”. I₀ represents the height of a dummy container (j=0).

In the case of xᵢⱼ=0, Formula (8) is self-explanatory because the height H of the storage location 14 is sufficiently large. In the case of xᵢⱼ=1, the height lᵢ of the container “i” is greater than or equal to the height lⱼ of the container “j” plus one.

The processing unit 12 performs a solving process of the linear programming problem according to the above objective function. In the solving process of the linear programming problem, an algorithm such as a simplex method or an interior point method is used to search for a solution represented by a combination of values of the decision variables xᵢⱼ that minimizes the value of the objective function while satisfying the above various constraints.

In the objective function expressed by Formula (4), in the case where the weight coefficient Wᵢⱼ is large, setting xᵢⱼ=1 increases the value of the objective function. Therefore, xᵢⱼ=0 is more likely to be obtained. That is, the container “j” is more likely to be stacked on the container “i”. Accordingly, in the case where the swapping probability in the retrieval order is high, re-handling is less likely to occur.

Conversely, in the case where the weight coefficient Wᵢⱼ is small, even setting xᵢⱼ=1 results in a small increase in the value of the objective function. Therefore, xᵢⱼ=1 is more likely to be permitted. That is, the container “i” is more likely to be stacked on the container “j”. Accordingly, in the case where the swapping probability in the retrieval order is low, re-handling is less likely to occur.

The processing unit 12 outputs arrangement information on the plurality of containers for the storage location 14, which is a result (solution) of the solving process. For example, the arrangement information may be displayed on a display device, not illustrated, or may be transmitted to another information processing apparatus via a network.

Hereinafter, before describing the effects of the container arrangement method according to the first embodiment, a formulation that does not use the weight coefficient Wᵢⱼ, that is, a formulation that does not take into account swapping in the retrieval order, and problems thereof will be described.

In the case where the weight coefficient Wᵢⱼ is not used, the linear programming problem is formulated using an objective function expressed by the following Formula (9). Constraints are formulated by the above-described Formulae (5) to (8).

$${\sum }_{( i , j ) ∈ {A}^{U}} {x}_{ij} \qquad ( 9 )$$

In Formula (9), A^{U} denotes a set of container pairs (containers “i” and “j”). Note that i>j and pᵢ>pⱼ (pk denotes the retrieval order of the container that is the k-th to be carried into the storage location 14). A^{U} is also regarded as a set of container pairs that affect the number of re-handling operations. It is possible to uniquely determine A^{U} from the order in which the containers are carried into the storage location and the retrieval order of the containers.

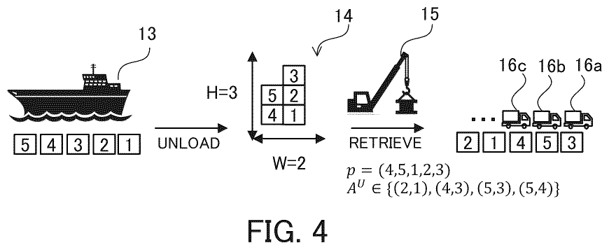

FIG. 4 illustrates an example of a retrieval order and a set A^{U} in the case where the number of containers is n=5. FIG. 4 illustrates an example in which the containers “1” to “5” are unloaded and carried into the storage location 14 in the order of the containers “1” to “5”. It is assumed that these containers are retrieved and loaded onto the vehicles 16a, 16b, 16c, and others using the crane 15 in the retrieval order of the containers “3”, “5”, “4”, “1”, and “2”. In this case, the set p of pk is expressed as p=(4, 5, 1, 2, 3). The set A^{U} is expressed as A^{U}ϵ{(2, 1), (4, 3), (5, 3), (5, 4)}.

In the case where the formulation method as described above is employed, the number of re-handling operations may increase if a change occurs in the retrieval order of the containers. That is, the above formulation method does not take into account robustness (the ability to maintain performance against data variations). In actual operations, variations in the retrieval order of containers may be significant due to, for example, delays in the arrival times of vehicles that will retrieve the containers. The arrival times are given as the predicted retrieval times of containers, but the times at which the containers are actually retrieved (i.e., the actual retrieval times) are not uniquely determined.

FIG. 5 illustrates an example of a result of investigating a history of actual retrieval times. In FIG. 5, the horizontal axis represents actual retrieval time (in minutes), and the vertical axis represents probability density. The predicted retrieval time is set to 0.

It is assumed that the actual retrieval time is not earlier than the predicted retrieval time. This is because, even if a vehicle that retrieves a certain container arrives at the storage location 14 prior to the predicted retrieval time of the container, the vehicle will wait until the predicted retrieval time for operational reasons.

As illustrated in FIG. 5, the probability density distribution of the actual retrieval time has no negative values, exhibits a high probability density in the vicinity of the time 0, and is fitted to a lognormal distribution 18. That is, in the example of FIG. 5, the probability density distribution of the actual retrieval time is represented by the lognormal distribution 18 based on the history of the actual retrieval times.

In the example of FIG. 5, the standard deviation (corresponding to the standard deviation of the error between the predicted retrieval time and the actual retrieval time) is 0.922, and the mean is 12.705 minutes.

From the above investigation result, the actual retrieval time Yᵢ of the container “i” is assumed to be expressed as Yᵢ=exp(log(μᵢ)+εᵢ). Here, μᵢ is the predicted retrieval time of the container “i”, and εᵢ follows a normal distribution with a mean of 0 and σ and is represented as N(0, σ).

As described above, since the actual retrieval times vary, the retrieval order of the containers may be swapped relative to the predicted retrieval order represented by the predicted retrieval time μᵢ.

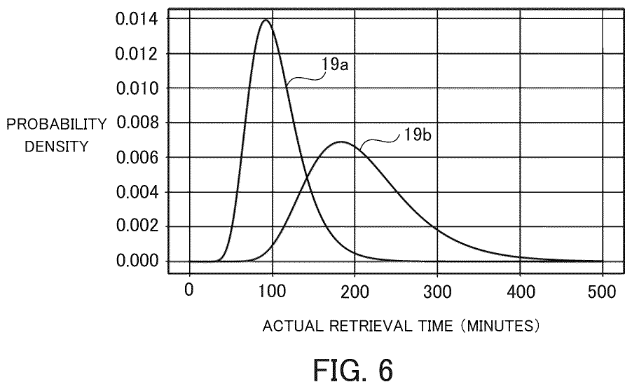

FIG. 6 is a diagram for describing an example in which the retrieval order of containers is swapped. In FIG. 6, the horizontal axis represents actual retrieval time (in minutes), and the vertical axis represents probability density.

A distribution 19a represents the probability density distribution of the actual retrieval time in the case where the predicted retrieval time is μᵢ=100 and the error is ε=N(0, σ=0.3). A distribution 19b represents the probability density distribution of the actual retrieval time in the case where the predicted retrieval time is μⱼ=200 and the error is ε=N(0, σ=0.3).

Since μᵢ=100<μⱼ=200 with respect to the predicted retrieval time, the container “i” precedes the container “j” in the predicted retrieval order. On the other hand, taking into account variations in the actual retrieval time, as seen from the overlap between the two distributions 19a and 19b, a case where the container “j” is retrieved before the container “i” may occur stochastically. As an example, μᵢ′=160>μⱼ′=150.

In the formulation method that does not use the weight coefficient Wᵢⱼ, such swapping in the retrieval order may increase the number of re-handling operations.

FIG. 1 illustrates an arrangement example of containers obtained as a solving result in the case where the weight coefficient Wᵢⱼ is not used. The containers “1”, “4”, and “7” are placed at the bottom of the storage location 14. The containers “2” and “3” are stacked in this order on the container “1”, and the containers “5” and “6” are stacked in this order on the container “4”. Further, the container “8” is stacked on the container “7”.

In the case where the retrieval order of the containers is “8”, “7”, “6”, “5”, “4”, “3”, “2”, and “1” in this container arrangement, the number of re-handling operations is zero. On the other hand, in the case where the retrieval order of the containers “7” and “8” is swapped and the retrieval order of the containers “5” and “6” is swapped, the retrieval order of the containers becomes “7”, “8”, “5”, “6”, “4”, “3”, “2”, and “1”. In this case, in the container arrangement as illustrated in FIG. 1, the container “8” needs to be moved to retrieve the container “7”, and the container “6” needs to be moved to retrieve the container “5”. That is, the above swapping in the retrieval order increases the number of re-handling operations to two.

By contrast, according to the container arrangement method of the first embodiment, the formulation using the weight coefficient Wᵢⱼ is performed, so that the arrangement of containers is determined according to the swapping probability in the retrieval order. Accordingly, for example, it is possible to distinguish between the case where the container “j” with the predicted retrieval time μⱼ=90 is stacked on the container “i” with the predicted retrieval time μᵢ=100 and the case where the container “j” with the predicted retrieval time μᵢ=30 is stacked thereon. This is because the closer the predicted retrieval times are, the higher the swapping probability in the retrieval order. That is, the weight coefficient Wᵢⱼ incorporated into the objective function probabilistically expresses that the container “j” with the predicted retrieval time close to that of the container “i” is likely to cause the re-handling.

FIG. 1 also illustrates an arrangement example of containers obtained as a solving result in the case where the weight coefficient Wᵢⱼ is used. The containers “1”, “4”, and “6” are placed at the bottom of the storage location 14. The containers “2” and “3” are stacked in this order on the container “1”, and the containers “5” and “8” are stacked in this order on the container “4”. Further, the container “7” is stacked on the container “6”.

In the case where the retrieval order of the containers is “8”, “7”, “6”, “5”, “4”, “3”, “2”, and “1” in this container arrangement, the number of re-handling operations is zero. On the other hand, in the case where the retrieval order of the containers “7” and “8” is swapped and the retrieval order of the containers “5” and “6” is swapped, the retrieval order of the containers becomes “7”, “8”, “5”, “6”, “4”, “3”, “2”, and “1”. Even in this case, in the container arrangement based on the container arrangement method of the first embodiment, the number of re-handling operations remains zero, i.e., the number of re-handling operations does not increase.

As described above, the processing unit 12 acquires a predicted retrieval time for each of a plurality of containers to be arranged in the storage location 14, and an estimated value of the standard deviation of the error between the predicted retrieval time and an actual retrieval time. Then, the processing unit 12 determines, for each container pair among the plurality of containers, a weight coefficient representing a swapping probability that the retrieval order is swapped relative to the predicted retrieval order represented by the predicted retrieval time, using the predicted retrieval times and the estimated value of the standard deviation. In addition, the processing unit 12 formulates a linear programming problem relating to the arrangement of the plurality of containers in the storage location 14, using an objective function in which decision variables are weighted by the weight coefficients. Each decision variable indicates, with respect to a container pair of a first container and a second container whose predicted retrieval time is later than that of the first container, whether the first container is stacked on the second container. Further, the processing unit 12 performs a solving process of the linear programming problem according to the objective function, and outputs arrangement information on the plurality of containers for the storage location 14, as a result of the solving process.

As described above, the containers are arranged based on the swapping probability. Thus, it is possible to present a container arrangement that suppresses an increase in the number of re-handling operations even when variations in the actual retrieval times cause swapping in the retrieval order.

### Second Embodiment

Next, a second embodiment will be described.

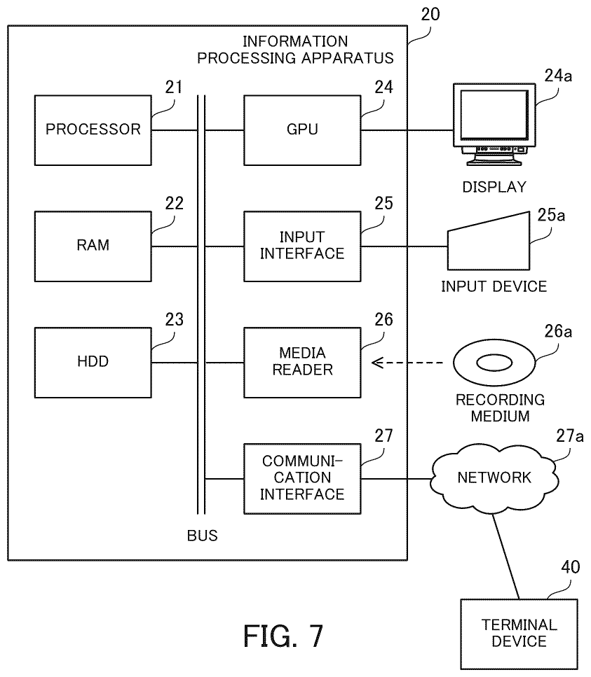

FIG. 7 illustrates an example of hardware of an information processing apparatus according to the second embodiment. FIG. 7 illustrates an information processing apparatus 20 for implementing a container arrangement method according to the second embodiment. The information processing apparatus 20 is able to implement the container arrangement method by executing a container arrangement program, for example. The information processing apparatus 20 may be referred to as a computer. The information processing apparatus 20 may be a client apparatus or a server apparatus.

The information processing apparatus 20 includes a processor 21, a random access memory (RAM) 22, a hard disk drive (HDD) 23, a graphics processing unit (GPU) 24, an input interface 25, a media reader 26, and a communication interface 27. These units are connected to a bus. The processor 21 corresponds to the processing unit 12 of the first embodiment. The RAM 22 or the HDD 23 corresponds to the storage unit 11 of the first embodiment.

The processor 21 is a processor such as a GPU or a central processing unit (CPU) including an arithmetic circuit that executes program instructions. The processor 21 loads at least a part of a program or data from the HDD 23 into the RAM 22 and executes the program. The processor 21 may include a plurality of processor cores. The information processing apparatus 20 may include a plurality of processors. Among a plurality of processes to be performed by the information processing apparatus 20, different processes may be performed by different processors. The processor may be referred to as processor circuitry. A set of a plurality of processors (multiprocessor) may be referred to as a “processor”.

The RAM 22 is a volatile semiconductor memory that temporarily stores programs to be executed by the processor 21 and data to be used by the processor 21 for computation. The information processing apparatus 20 may include a memory of a type other than the RAM 22, or may include a plurality of memories.

The HDD 23 is a non-volatile storage device that stores software programs such as an operating system (OS), middleware, and application software, and data. The programs include, for example, a container arrangement program that causes the information processing apparatus 20 to perform a process of computing the arrangement of containers so as to reduce the number of re-handling operations. The information processing apparatus 20 may include another type of storage device such as a flash memory or a solid state drive (SSD), or may include a plurality of non-volatile storage devices.

The GPU 24 outputs images to a display 24a connected to the information processing apparatus 20 in accordance with instructions from the processor 21. As the display 24a, a cathode ray tube (CRT) display, a liquid crystal display (LCD), a plasma display panel (PDP), an organic electro-luminescence (OEL) display, or the like may be used.

The input interface 25 acquires input signals device 25a connected to the information from an input processing apparatus 20 and outputs the input signals to the processor 21. As the input device 25a, a pointing device such as a mouse, a touch panel, a touch pad, or a track ball, a keyboard, a remote controller, a button switch, or the like may be used. A plurality of types of input devices may be connected to the information processing apparatus 20.

The media reader 26 is a reading device that reads programs and data recorded on a recording medium 26a. As the recording medium 26a, for example, a magnetic disk, an optical disc, a magneto-optical disk (MO), a semiconductor memory, or the like may be used. Magnetic disks include a flexible disk (FD) and an HDD. Optical discs include a compact disc (CD) and a digital versatile disc (DVD).

For example, the media reader 26 copies a program or data from the recording medium 26a to another recording medium such as the RAM 22 or the HDD 23. The read program is executed by, for example, the processor 21. The recording medium 26a may be a portable recording medium, and may be used to distribute programs and data. The recording medium 26a and the HDD 23 may be referred to as computer-readable storage media.

The communication interface 27 is connected to a network 27a and communicates with other information processing apparatuses via the network 27a. In the example of FIG. 7, the communication interface 27 communicates with a terminal device 40 via the network 27a. The terminal device 40 may be a personal computer (PC), a smartphone, a smartwatch, a tablet terminal, or the like. The terminal device 40 is provided, for example, in a port facility where container handling is performed. The terminal device 40 may be installed in the cockpit of a crane that unloads containers from a ship and places the containers in a storage location. The communication interface 27 may be a wired communication interface connected to a communication device such as a switch via a cable, or may be a wireless communication interface connected to a base station via a wireless link.

Next, the functions of the information processing apparatus 20 will be described.

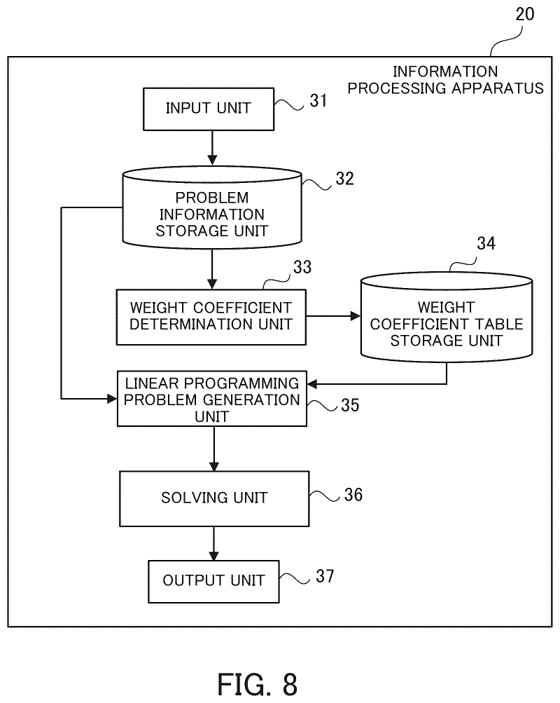

FIG. 8 is a block diagram illustrating an example of functions of the information processing apparatus.

The information processing apparatus 20 includes an input unit 31, a problem information storage unit 32, a weight coefficient determination unit 33, a weight coefficient table storage unit 34, a linear programming problem generation unit 35, a solving unit 36, and an output unit 37. With these units, the same functions as those of the storage unit 11 and the processing unit 12 illustrated in FIG. 1 are implemented.

The input unit 31, the weight coefficient determination unit 33, the linear programming problem generation unit 35, the solving unit 36, and the output unit 37 may be implemented by, for example, program modules executed by the processor 21. The problem information storage unit 32 and the weight coefficient table storage unit 34 are implemented by using a storage space secured in the RAM 22 or the HDD 23.

The input unit 31 acquires problem information on a linear programming problem relating to the arrangement of a plurality of containers in a storage location such that an increase in the number of re-handling operations during retrieval is suppressed. The problem information includes a predicted retrieval time μᵢ for each of the plurality of containers, and an estimated value σ of the standard deviation of the error between the predicted retrieval time Ui and an actual retrieval time. Further, the problem information includes the width W and the height H of the storage location, which are used for determining the constraints given by Formulae (7) and (8). The problem information may be input by the user operating the input device 25a, or may be received from another computer (for example, the terminal device 40) via the network 27a.

The problem information storage unit 32 stores the problem information acquired by the input unit 31.

The weight coefficient determination unit 33 determines, for each container pair among the plurality of containers, a weight coefficient Wᵢⱼ representing a swapping probability that the retrieval order will be swapped, using the predicted retrieval time μᵢ and the estimated value σ of the standard deviation of the error between the predicted retrieval time μᵢ and the actual retrieval time. The weight coefficient determination unit 33 is able to determine the weight coefficient Wᵢⱼ using Formula (2) and Formula (3).

The weight coefficient table storage unit 34 stores a weight coefficient table including the weight coefficients Wᵢⱼ determined by the weight coefficient determination unit 33. Let n denote the total number of containers n. For example, among n×n weight coefficients Wᵢⱼ, the weight coefficients Wᵢⱼ for i=j do not need to be stored.

The linear programming problem generation unit 35 formulates a linear programming problem relating to the arrangement of the plurality of containers in the storage location, using an objective function in which the decision variable xᵢⱼ is weighted by the weight coefficient Wᵢⱼ. The objective function is expressed by the above-described Formula (4). The decision variable xᵢⱼ indicates, with respect to a container pair of a container i and a container j whose predicted retrieval time is later than that of the container i, whether the container i is stacked on the container j. xᵢⱼ=1 if the container i is stacked on the container j, and xᵢⱼ=0 otherwise.

In the case where the weight coefficient Wᵢⱼ is large, setting xᵢⱼ=1 increases the value of the objective function. Therefore, xᵢⱼ=0 is more likely to be obtained. That is, the container “j” is more likely to be stacked on the container “i”. Accordingly, in the case where the swapping probability in the retrieval order is high, re-handling is less likely to occur.

In the case where the weight coefficient Wᵢⱼ is small, even setting xᵢⱼ=1 results in a small increase in the value of the objective function. Therefore, xᵢⱼ=1 is more likely to be permitted. That is, the container “i” is more likely to be stacked on the container “j”. Accordingly, in the case where the swapping probability in the retrieval order is low, re-handling is less likely to occur.

The objective function in which the weight coefficient Wᵢⱼ is incorporated in this manner is also regarded as a model that minimizes the number of re-handling operations.

The linear programming problem generation unit 35 further formulates the constraints in the linear programming problem relating to the arrangement of containers in the storage location, using the above-described Formulae (5) to (8).

The solving unit 36 performs the solving process of the linear programming problem according to the objective function. In the solving process of the linear programming problem, an algorithm such as a simplex method or an interior-point method is used to search for a solution represented by a combination of values of the decision variables xᵢⱼ that minimizes the value of the above-described objective function while satisfying the above-described various constraints.

The output unit 37 outputs arrangement information on the plurality of containers for the storage location, which is the result (solution) of the solving process. The output unit 37 may display the arrangement information on the display 24a, or may transmit the arrangement information to another computer (for example, the terminal device 40 or the like) via the network 27a. Alternatively, the output unit 37 may store the arrangement information in a storage device such as the HDD 23.

Next, the processing procedure of the information processing apparatus 20 will be described.

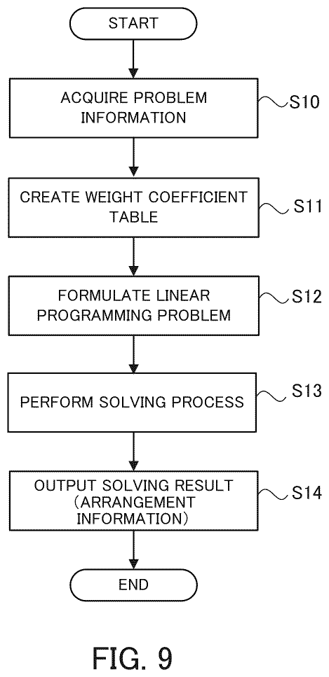

FIG. 9 is a flowchart illustrating an example of a processing procedure of the information processing apparatus according to the second embodiment. Hereinafter, the process illustrated in FIG. 9 will be described in order of step numbers.

[Step S10] The input unit 31 acquires problem information on a linear programming problem relating to the arrangement of a plurality of containers in a storage location such that an increase in the number of re-handling operations during retrieval is suppressed. The acquired problem information is stored in the problem information storage unit 32.

[Step S11] The weight coefficient determination unit 33 determines the weight coefficient Wᵢⱼ for each container pair using Formulae (2) and (3), and creates a weight coefficient table including the determined weight coefficient Wᵢⱼ. The weight coefficient table is stored in the weight coefficient table storage unit 34.

[Step S12] The linear programming problem generation unit 35 formulates the linear programming problem relating to the arrangement of the plurality of containers, using an objective function in which the decision variable xᵢⱼ is weighted by the weight coefficient Wᵢⱼ included in the weight coefficient table stored in the weight coefficient table storage unit 34.

[Step S13] The solving unit 36 performs a solving process of the linear programming problem according to the objective function.

[Step S14] The output unit 37 outputs arrangement information on the plurality of containers for the storage location, which is the result (solution) of the solving process. This completes the process of the information processing apparatus 20.

Heretofore, the processing content of the information processing apparatus 20 according to the second embodiment has been described. As described earlier, the processing content may be implemented by causing the information processing apparatus 20 to execute a program.

The program may be recorded on a computer-readable recording medium (for example, the recording medium 26a). Examples of the recording medium include a magnetic disk, an optical a magneto-optical disk, a disc, semiconductor memory, and others. The program may be recorded on portable recording media, which are then distributed. In this case, the program may be copied from a portable recording medium to another recording medium (for example, the HDD 23) and executed.

The following describes two examples of numerical experiments for comparing the effects of the container arrangement method using Wᵢⱼ as described above with the effects of the container arrangement method not using Wᵢⱼ.

### Experimental Example 1

Experimental Example 1 is an example where an estimated value σ of the standard deviation of the error matches the actual value of the standard deviation. Problem information to be input indicates that the number of containers is 540, the height H of a storage location is 5, and the width W of the storage location is 120.

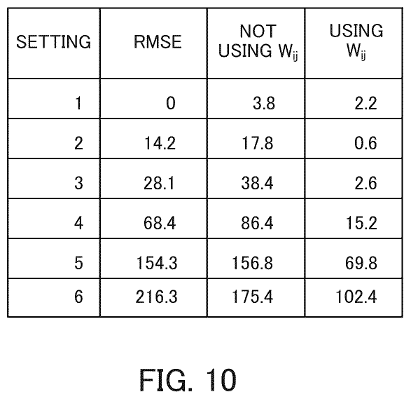

FIG. 10 illustrates the results of Experimental Example 1.

FIG. 10 presents objective function values obtained with the container arrangement method using Wᵢⱼ and the container arrangement method not using Wᵢⱼ, for each of six settings (for example, the setting of the predicted retrieval time μᵢ). The objective function value is an average value over five instances. FIG. 10 further presents values of the root mean squared error (RMSE) between the actual retrieval times and the predicted retrieval times.

As seen in FIG. 10, it is confirmed that, even in the case where there is an error between the predicted retrieval time and the actual retrieval time, the container arrangement method using Wᵢⱼ yields small objective function values, compared with the container arrangement method not using Wᵢⱼ, thereby suppressing an increase in the number of re-handling operations.

### Experimental Example 2

Experimental Example 2 is an example in which the estimated value σ of the standard deviation of the error does not match the actual value of the standard deviation. Problem information to be input indicates that the number of containers is 540, the height H of a storage location is 5, and the width W of the storage location is 120.

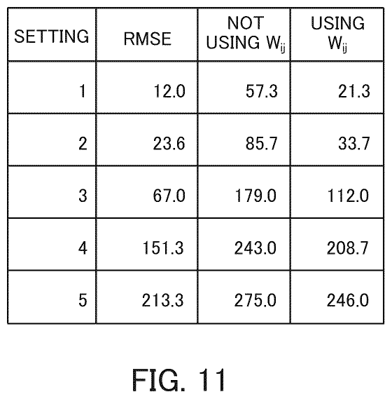

FIG. 11 illustrates the results of Experimental Example 2.

FIG. 11 presents objective function values obtained with the container arrangement method using Wᵢⱼ and the container arrangement method not using Wᵢⱼ, for each of five settings. The objective function value is an average value over three instances. FIG. 11 further presents the RMSE values between the actual retrieval times and the predicted retrieval times.

As seen in FIG. 11, it is confirmed that, even in the case where the estimated value σ of the standard deviation of the error does not match the actual value of the standard deviation, the container arrangement method using Wᵢⱼ yields small objective function values, compared with the container arrangement method not using Wᵢⱼ, as in Experimental Example 1. That is, it is understood that an increase in the number of re-handling operations is suppressed.

### Application Example

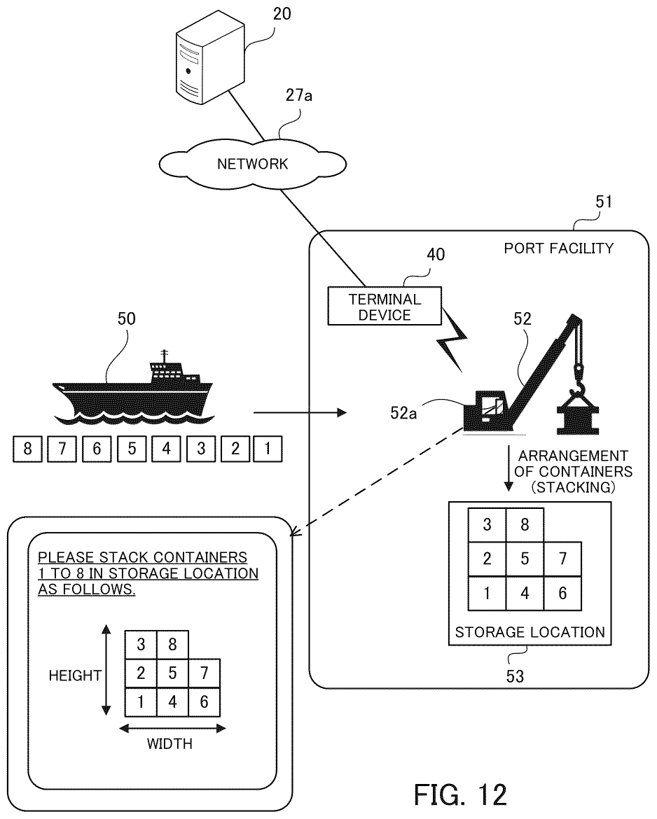

FIG. 12 illustrates an application example of the container arrangement method according to the second embodiment.

As illustrated in FIG. 12, for example, prior to the arrival time of a ship 50 loaded with containers “1” to “8”, the terminal device 40 installed in a port facility 51 requests the information processing apparatus 20 to compute a container arrangement via the network 27a. Information transmitted from the terminal device 40 to the information processing apparatus 20 via the network 27a together with the request may include the predicted retrieval times μ₁ to μ₈ of the containers “1” to “8”, the above-described estimated value σ of the standard deviation of the error, and the height H and the width W of a storage location 53.

The information processing apparatus 20 that has received the request performs the solving process in accordance with the process illustrated in FIG. 9 and outputs arrangement information as a solving result. In the example of FIG. 12, the arrangement information is transmitted from the information processing apparatus 20 to the terminal device 40 via the network 27a.

At the arrival time of the ship 50, the terminal device 40 that has received the arrangement information transmits the arrangement information to a display terminal 52a provided in a crane 52, which unloads and arranges the containers “1” to “8” in the storage location 53, via wireless communication, for example, to display the arrangement information.

FIG. 12 illustrates an example of the arrangement information displayed on the display screen of the display terminal 52a. The operator of the crane 52 arranges the containers “1” to “8” in the storage location 53 on the basis of the displayed arrangement information. By doing so, a container arrangement that will need less re-handling during the container retrieval is implemented.

The terminal device 40 may be provided in the crane 52. In the case where the crane 52 is capable of automatic operation, the transceiver device of the crane 52 may receive the arrangement information, and the control device of the crane 52 may automatically place the containers “1” to “8” in the storage location 53 according to the arrangement information.

Although the above has described an application example in a port facility, the container arrangement method of the present disclosure is also applicable to facilities other than port facilities. For example, in an airport facility, the container arrangement method of the present disclosure is also applicable as an arrangement method for temporarily arranging a plurality of contains unloaded from an aircraft in a storage location, for subsequent retrieval.

In one aspect, it is possible to present an arrangement of containers that suppresses an increase in the number of re-handling operations.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable storage medium that stores a computer program that causes a computer to perform a process comprising:
acquiring a predicted retrieval time for each of a plurality of containers to be arranged in a predetermined area, and an estimated value of a standard deviation of an error between the predicted retrieval time and an actual retrieval time;
determining, for each container pair among the plurality of containers, a weight coefficient representing a swapping probability that a retrieval order is swapped relative to a predicted retrieval order represented by the predicted retrieval time, using the predicted retrieval time and the estimated value;
formulating a linear programming problem relating to an arrangement of the plurality of containers in the predetermined area, using an objective function in which decision variables are weighted by weight coefficients, the decision variables each indicating, with respect to a container pair of a first container and a second container having a later predicted retrieval time than the first container, whether the first container is stacked on the second container;
performing a solving process of the linear programming problem according to the objective function; and
outputting arrangement information on the plurality of containers for the predetermined area, as a result of the solving process.

2. The non-transitory computer-readable storage medium according to claim 1, wherein the estimated value is calculated based on a history of the actual retrieval time.

3. The non-transitory computer-readable storage medium according to claim 2, wherein a probability density distribution of the actual retrieval time is represented by a lognormal distribution based on the history.

4. The non-transitory computer-readable storage medium according to claim 1, wherein
the linear programming problem relates to the arrangement of the plurality of containers, which are unloaded from a ship and arranged in the predetermined area that is a temporary storage location before being retrieved by a plurality of vehicles, and
the objective function represents a number of re-handling operations during retrieval.

5. The non-transitory computer-readable storage medium according to claim 4, wherein the retrieval order is swapped due to a delay in an arrival time of any of the plurality of vehicles at the predetermined area.

6. An information processing apparatus comprising:
a memory; and
a processor coupled to the memory and the processor configured to:
acquire a predicted retrieval time for each of a plurality of containers to be arranged in a predetermined area, and an estimated value of a standard deviation of an error between the predicted retrieval time and an actual retrieval time;
determine, for each container pair among the plurality of containers, a weight coefficient representing a swapping probability that a retrieval order is swapped relative to a predicted retrieval order represented by the predicted retrieval time, using the predicted retrieval time and the estimated value;
formulate a linear programming problem relating to an arrangement of the plurality of containers, using an objective function which decision variables are weighted by weight coefficients, the decision variables each indicating, with respect to a container pair of a first container and a second container having a later predicted retrieval time than the first container, whether the first container is stacked on the second container;
perform a solving process of the linear programming problem according to the objective function; and
output arrangement information on the plurality of containers for the predetermined area, as a result of the solving process.

7. A container arrangement method comprising:
acquiring, by a processor, a predicted retrieval time for each of a plurality of containers to be arranged in a predetermined area, and an estimated value of a standard deviation of an error between the predicted retrieval time and an actual retrieval time;
determining, by the processor, for each container pair among the plurality of containers, a weight coefficient representing a swapping probability that a retrieval order is swapped relative to a predicted retrieval order represented by the predicted retrieval time, using the predicted retrieval time and the estimated value;
formulating, by the processor, a linear programming problem relating to an arrangement of the plurality of containers, using an objective function in which decision variables are weighted by weight coefficients, the decision variables each indicating, with respect to a container pair of a first container and a second container having a later predicted retrieval time than the first container, whether the first container is stacked on the second container;
performing, by the processor, a solving process of the linear programming problem according to the objective function; and
outputting, by the processor, arrangement information on the plurality of containers for the predetermined area, as a result of the solving process.
